(19) United States
(12) Patent Application Publication
(10) Pub. No.: US 2011/0191029 A1
(43) Pub. Date: Aug. 4, 2011

(54) SYSTEM AND METHOD FOR WELL TEST DESIGN, INTERPRETATION AND TEST OBJECTIVES VERIFICATION

(76) Inventors: Younes Jalali, Beijing (CN); Shahram Amini, Paris (FR)

(21) Appl. No.: 12/921,193

(22) PCT Filed: Mar. 9, 2009
(86) PCT No.: PCT/US2009/036515

§ 371 Date: Dec. 7, 2010

Related U.S. Application Data
(60) Provisional application No. 61/035,233, filed on Mar. 10, 2008.
(60) Provisional application No. 61/095,158, filed on Sep. 8, 2008.
(60) Provisional application No. 61/104,050, filed on Oct. 9, 2008.

(51) Int. Cl. G06F 19/00; G01V 3/18

(52) U.S. Cl. 702/6

(57) ABSTRACT

A method and system for well test optimization provides test parameters and variation range therefor, independently from preliminarily reservoir and downhole fluid data; and repeatedly executes the test for each parameter to obtain real-time measured data, and interpreted data that is compared to the variation range for meeting a test objective. A method and system for well test design and interpretation, includes a testing manager having testing hardware/gauge metrology; a geological model; dynamic/static engineering data acquisition; and a reservoir model generator. A method and system for well test design and interpretation generates a test plan and an initial reservoir model and data from real/near-real-time, surface/downhole/manual data, aggregated data based on quality control/assurance, and optimization data based thereon and simulated downhole data; models/interprets the optimization data to meet test objectives for terminating/continuing the test plan; modifies the optimization; and/or generates reports from the modeling/interpretation when terminating the test plan.

### CROSS REFERENCE TO RELATED DOCUMENTS

The present disclosure claims benefit of priority to U.S. Provisional Patent Application Ser. No. 61/035,233 of JALALI et al., entitled “METHOD TO VERIFY RESERVOIR INFORMATION CAPTURE DURING EXPLORATION WELL TEST OPERATIONS,” filed on Mar. 10, 2008, U.S. Provisional Patent Application Ser. No. 61/095,158 of KUCHUK et al., entitled “SYSTEM AND METHOD FOR WELL TEST DESIGN AND INTERPRETATION,” filed on Sep. 8, 2008, and U.S. Provisional Patent Application Ser. No. 61/104,050 of KUCHUK et al., entitled “SYSTEM AND METHOD FOR WELL TEST DESIGN AND INTERPRETATION,” filed on Oct. 9, 2008, the entire contents of all of which are hereby incorporated by reference herein.

### BACKGROUND

1. Technical Field

The present disclosure generally relates to methods and systems for well testing, including hydrocarbon formation evaluation techniques, and more particularly to a system and method for well test design, interpretation and test objectives verification.

2. Discussion of Background Art

Well testing is a common technique used to obtain parameters describing the reservoir. Data obtained from downhole instrumentation and fluid samples from a hydrocarbon reservoir provide information such as type and behavior of the reservoir fluids, formation permeability, and the reservoir boundary. Such parameters enable determination and enhancement of well productivity and protection of the well. The reservoir parameters are derived after completion of the test by processing and interpreting the measurement data gathered during the test.

Well tests are designed based on parameters that are preliminarily known to the operator of the well test, such as preliminary reservoir, test equipment, and fluid parameters. Thus, well tests include a test program of a given duration in order to attain the previously defined test objectives, i.e., to obtain a set of measurements from which the desired reservoir parameters may be unambiguously derived.

However, it is not always possible to properly decide about a test sequence in advance. For example, expected and real reservoir parameters may differ considerably, and consequently, the test may not be properly designed by the test designer. This is especially true in the context of exploration wells where uncertainties in estimated reservoir parameters can be important. Therefore, the test program or individual segments of the test program (flowing and shut-in periods) may be too long or too short, which leads to waste of rig and testing equipment time or to the non-achievement of the defined test objectives, respectively.

In addition, crucial decisions relating to well production efficiency, operations, and safety, well workover, and reservoir management can require huge amounts of data, including measurements of well downhole and surface pressure, temperature, flow rate, etc. However, conventional systems and methods suffer from not being able to efficiently process the acquired data, including downhole pressure measurement interpretation.

Further, in the traditional process of design, implementation, and interpretation of a well test, various processing steps or stages are performed separately and advances in new technologies have enabled optimization of each individual stage in order to have the best results at each stage, but separately from other stages of the operations. Accordingly, although there have been software and platforms developed for each stage, an overall system and method is needed to integrate all of the suitable well testing processes, from design to interpretation, in a single platform.

### SUMMARY OF THE DISCLOSURE

Therefore, there is a need to provide a method and a system for iteratively verifying in real-time during the well test whether the test objectives are being met, thereby providing the possibility to alter the test program if necessary. Both the test duration and the interpretation of the test data to obtain the reservoir parameters can thus be optimized. The benefit of real-time analysis includes the fact that it provides the opportunity of taking remedial actions before the test (or test sequence) is done. This way the test duration or test sequence can be changed to guaranty achievement of well test objectives.

Accordingly, exemplary aspects relate to methods and systems for optimizing a well test in real-time, the well test being adapted to provide one or a plurality of well test parameters.

In an exemplary aspect, the exemplary method can include defining an expected variation range of data for each well test parameter independently from preliminarily determined reservoir and downhole fluid data, executing a well test for each well test parameter to obtain measured data, processing the measured data for each well test parameter in real-time to obtain interpreted data, comparing the interpreted data for each well test parameter to the corresponding expected variation range to determine if a test objective is met, and if not, iteratively repeating the executing, the processing, and the comparing steps for each well test parameter until the test objective is met.

In an exemplary aspect, the exemplary system includes an acquisition downhole tool to execute a well test for each well test parameter to obtain measured data, and a processor to process the measured data for each well test parameter in real-time to obtain interpreted data, to compare the interpreted data for each well test parameter to a corresponding expected variation range, previously defined for each well test parameter independently from preliminary reservoir and downhole fluid data, to determine if a test objective is met, and if not to allow the iterative repeating of the test well execution, of the measured data processing and of the interpreted data comparison for each well test parameter until the test objective is met.

In addition, there is a need for a method and system that addresses discovered problems with existing systems and methods for well testing. The above and other needs and problems are addressed by an improved method and system, referred to as a Test Design and Interpretation Process (TDIP), for well test design and interpretation, that allow for the making of crucial decisions related to well production efficiency, operations, and safety, well workover, and reservoir management based on real-time measurements of well downhole and surface pressure, temperature, flow rate, and the like. Data is acquired from various tools, such as a multiphase flowmeter, e.g., an assignee's flowmeter, for measuring the flow rate and the oil, water and gas content of the well effluent continuously with downhole pressure measurements during reservoir testing. The data is interpreted real-time to enable production and reservoir engineers and managers to optimize well completion, perforation, lift, production, recovery, and the like. As each well represents a large investment in drilling and completion, the reservoir and well knowledge gained from dynamic testing data integrated by the TDIP, advantageously, can help to reduce the number of development wells employed, and provide for a better prediction of field performance, the ability to pinpoint future infill drilling opportunities, and the like.

In an exemplary embodiment, the exemplary system and method can include the TDIP used in conjunction with a Testing Manager Platform and Real-Time data acquisition system (Testing Manager) to enable exploration and production companies and testing reservoir engineers to enhance and add value to well testing operations, test design, interpretation, and successful completion of a well test. Furthermore, the exemplary system and method help to reduce uncertainty in complex geological systems. The TDIP synthesizes the well test measurements, such as pressure, flow rate, temperature, and the like, with a geological model of the reservoir to model these measurements and anticipate the encounter of geological features, such as faults, fracture, and the like, while testing, in order not to terminate well testing prematurely. Advantageously, the novel well test design and interpretation system and method is continuous until the termination of the well test, wherein test data are received from various sensors via the acquisition system into the Testing Manager. The reservoir model is continuously updated as data comes in via the TDIP, wherein the Testing Manager provides real-time connections to design, interpretation, other toolboxes, and the like. The TDIP combined with the Testing Manager enables faster decision making with the potential to identify and reduce nonproductive testing time with and test design and interpretation. Advantageously, the TDIP can be used to update the model in real-time, enabling faster decision making and reducing testing time, and saving time and money.

Accordingly, in an exemplary aspect, there is provided a method, system and apparatus for well test design and interpretation, including a testing manager system, which includes at least one of testing hardware and gauge metrology; a geological model coupled to the testing manager system; a dynamic and static engineering data acquisition system coupled to the geological model; and a reservoir modeling system coupled to the dynamic and static engineering data acquisition system to generate a reservoir model.

Further exemplary embodiments provide an improved method and system for well test design and interpretation including an overall Testing Design and Interpretation Process (TDIP) that advantageously integrates all of the suitable well testing processes, from design to interpretation, in a single platform.

Accordingly, in an exemplary aspect, there is provided a method, system and computer program product for well test design and interpretation that generates a test plan and an initial reservoir model based on at least one of an expected reservoir model, properties, fluid properties, and/or metrology; generates data streams based on the test plan from real/near-real-time, surface, downhole, and/or manual data sources; generates an aggregated data stream based on quality control/assurance on the data streams; generates data for optimization based on the aggregated data stream and simulated downhole data sent to the quality control/assurance; models/interprets the optimization data including reservoir simulation and modeling to determine if test objectives are met for terminating/continuing the test plan and generates data sent for the optimization for modifying assumptions therein; and/or reports data received from the modeling/interpretation when terminating the test plan.

Still other aspects, features, and advantages of the present disclosure are readily apparent from the entire description thereof, including the figures, which illustrate a number of exemplary embodiments and implementations. Exemplary aspects of the present disclosure are also capable of other and different embodiments, and its several details can be modified in various respects, all without departing from the spirit and scope of the present disclosure. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings and in which like reference numerals refer to similar elements and in which:

FIGS. 1-4 are used to illustrate exemplary methods and systems for verification of attainment of test objectives during well tests;

FIG. 5 is used to illustrate an exemplary Test Design and Interpretation Process (TDIP) for well test design and interpretation;

FIG. 6 is used to illustrate an exemplary Testing Manager employed for the well test design and interpretation of FIG. 5;

FIG. 7 is used to illustrate an exemplary Geological Model employed for the well test design and interpretation of FIG. 5;

FIG. 8 is used to illustrate exemplary Dynamic and Static Engineering data employed for the well test design and interpretation of FIG. 5;

FIG. 9 is used to illustrate exemplary Reservoir Modeling employed for the well test design and interpretation of FIG. 5;

FIG. 10 is used to illustrate exemplary Test Operation and Data Acquisition for well test design and interpretation;

FIG. 11 is used to illustrate exemplary Real Time Wellsite and Remote Site Interpretation for well test design and interpretation;

FIG. 12 is used to illustrate exemplary Final Analysis, including Verification, Uncertainty, Nodal, and Reserve Estimation for well test design and interpretation;

FIG. 13 is used to illustrate an exemplary process of a Test Design Segment of the exemplary Testing Design and Interpretation Process (TDIP);

FIG. 14 is used to illustrate an exemplary overall TDIP workflow;

FIG. 15 is used to illustrate an exemplary QA/QC process step of the TDIP workflow of FIG. 14;

FIG. 16 is used to illustrate an exemplary Data Processing process step of the TDIP workflow of FIG. 14; and

FIG. 17 is used to illustrate an exemplary Modeling/Interpretation process step of the TDIP workflow of FIG. 14.

### DETAILED DESCRIPTION

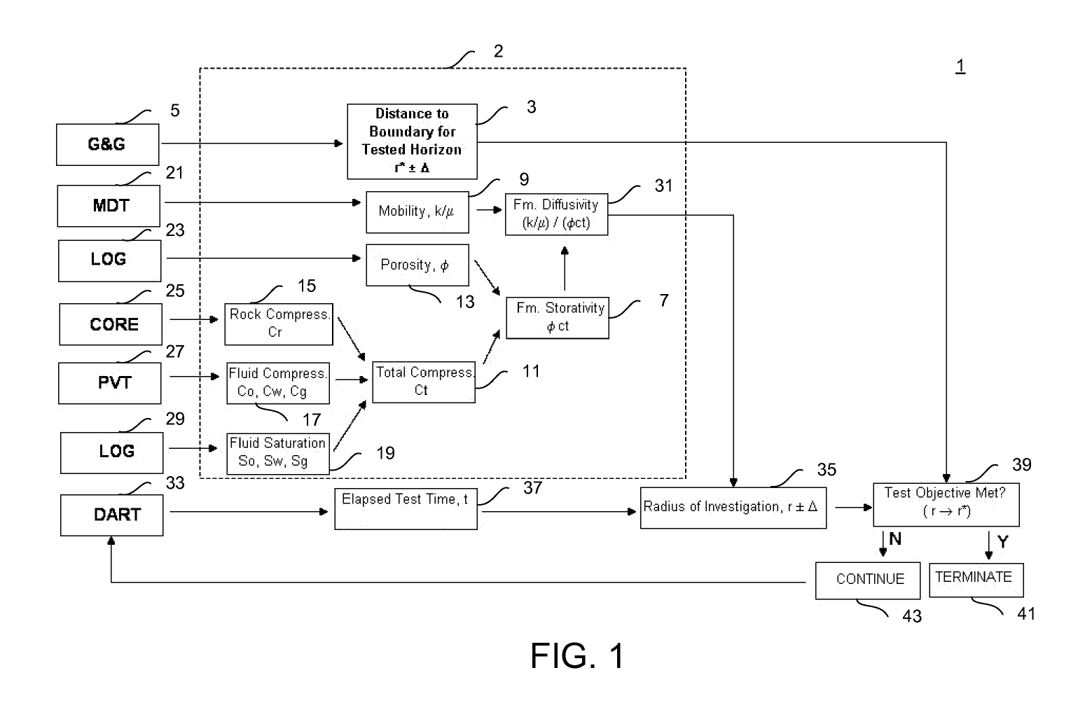

Referring now to the drawings, wherein like reference numerals may designate identical or corresponding parts throughout the several views, and more particularly to FIGS. 1-17 thereof, there are illustrated exemplary systems and methods for well test design, interpretation and test objectives verification.

The present disclosure includes recognition that in order to avoid loss of measurement data or waste of resources it has been proposed to assign the test engineer as the only responsible person for supervision of the well test procedure over the whole periods of test design, implementation, data acquisition and their quality control, and interpretation (see, e.g., Barnum and Vela “Testing Exploration Wells by Objectives,” paper SPE 13184 presented at the SPE Annual Technical Conference and Exhibition, Houston, Tex., USA, 16-19 Sep. 1984). Emphasis is placed on the importance of design execution of the test based on a detailed list of test objectives, wherein important test objectives can be missed due to failure in data acquisition (e.g., test sequences shorter than needed and/or low data quality).

Recent advances in well-testing data acquisition systems have enabled real-time data acquisition. Real-time transient pressure analysis has been proposed, allowing for optimizing test sequences and their durations during the test of an exploration well in order to meet the previously defined test objectives (see, e.g., Adeyemi, Cribbs, and Lindo “Optimizing Well Test Sequence and Duration Using Real-Time Pressure Transient Analysis (RT-PTA),” paper IPTC 10747 presented at the International Petroleum Technology Conference, Doha, Qatar, 21-23 Nov. 2005).

Accordingly, the exemplary embodiments relate to methods and systems for processing streaming data acquired during well test operations, such as drillstem tests (DST). Specifically, exemplary methods and systems are provided to verify whether test objectives are met while the test is in progress and acquired data are being processed. Test objectives may be related to capturing specific reservoir information or parameters, such as reservoir boundary (e.g., radius of investigation), permeability, pressure, and the like. The actual extraction of reservoir information from the test data would happen upon completion of the interpretation process after the test. However, during the test, the exemplary methods and systems can be used to verify if the set of measurement data contains the desired information. If not, the test program can be modified.

The exemplary method of optimization of a well test can include the following steps. First, all the available reservoir and downhole fluid data are collected prior to the well test. These preliminary data can include, for example, fluid viscosity data, rock permeability data, or estimates of initial reservoir pressure and reservoir permeability. The preliminary data can be found among geology and geophysics data, seismic data, well log data, core and fluid analysis data, and drilling, testing, completion data, and the like.

The preliminary data are then used to define an expected range of variation for well test parameters that figure among the test objectives. The expected range of variation for a specific well test parameter corresponds to a range of values that this parameter is expected to lie within. Within a given well test, each well test objective is considered independently (e.g., “atomization” of objectives). Each test objective has its own analysis process or workflow to ensure that the objective is met, and each test objective is associated with its own sources of preliminary data.

Then, the well test and measurement data acquisition are started. Measurements and acquisition may be carried out using appropriate downhole tools and equipment, for example, such as through a data acquisition and reporting tool (DART). The measurement data are then processed or interpreted in real- or near-real-time in order to obtain interpreted data.

A comparison of the interpreted data and the expected range of variation of each well test parameter indicates whether or not a corresponding well test objective is met. If a test objective for a specific well test parameter is met, the measurement and acquisition of data is terminated for this parameter. If a test objective for a specific well test parameter is not met, the duration of the well test or a segment of the well test can be adapted. The interpretation in real-time of the measured data and the comparison of the interpreted data to the expected variation range of the corresponding well test parameter is iteratively repeated until the test objective is achieved. The well test continues until all the test objectives of the well test are achieved.

Therefore, the exemplary methods and systems, advantageously, ensure the “interpretability” of the test data during the test (e.g., that specific reservoir information or parameters that have motivated the test can actually be obtained) and can be used to determine the well test parameters reservoir boundary, permeability, and initial reservoir pressure.

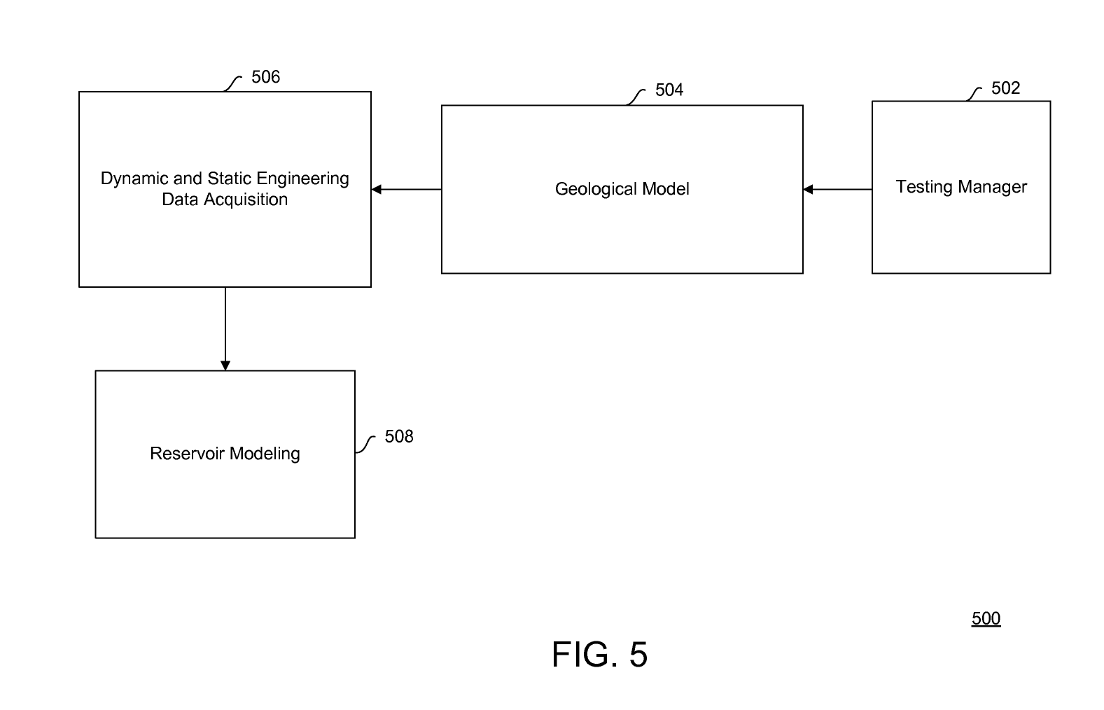

FIGS. 1-4 are used to illustrate exemplary systems and methods for verification of attainment of test objectives during well tests, and which can be used alone or in combination with the exemplary embodiments of FIGS. 5-17.

In FIG. 1, the exemplary method and system 1 is adapted to the well test parameter reservoir boundary or radius of investigation (e.g., the calculation of the radius of investigation and the position of the boundary). Boundaries can include faults, pinch-outs, or any other forms of unconformities, and the like.

The exemplary method and system 1 can be used for gathering various types of preliminary reservoir and downhole fluid data 2. For example, data about the existence of possible reservoir boundaries 3, which stem from geology and geophysics (G&G) data 5, can be gathered. From these data, a distance to a reservoir boundary r* can be derived. Formation storativity data 7 and reservoir fluid mobility data 9 also can be gathered. Formation storativity 7 is the product of total compressibility 11 and rock porosity 13. Reservoir fluid mobility 9 is the ratio of rock permeability to fluid viscosity. Formation storativity 7 and reservoir fluid mobility 9 can be used to describe the velocity of propagation of pressure changes in the reservoir.

Total compressibility data 11 are derived from rock compressibility data 15, fluid compressibility data 17, and fluid saturation data 19. These reservoir and downhole fluid data 2 are obtained from available core analyses 25 (e.g., for rock porosity 13 based on log data 23, rock compressibility 15 based on core data 25, and local rock permeability), PVT (pressure, volume, temperature) analyses 27 (e.g., for downhole fluid type, fluid viscosity, and compressibility 17), well logs 29 (e.g., for fluid saturation 19), and formation testing 21 (e.g., for reservoir fluid mobility 9). Formation testing 21 can, for example, include repeat formation testing (RFT) or modular reservoir dynamics testing (MDT).

The combination of the formation storativity 7 and the reservoir fluid mobility 9 allows inferring the formation diffusivity 31. From all these preliminary reservoir and downhole fluid data 2, an expected range for the time of production needed to achieve a certain radius of investigation or to find a reservoir boundary at a certain distance from the well can be derived (e.g., an expected range of variation of the radius of investigation r*±Δ can be derived).

As the well test starts, the measured data are gathered through a data acquisition and reporting tool (DART) 33. The radius of investigation r±Δ, 35, is calculated using the elapsed test time 37 (e.g., a shut-in time), and the formation diffusivity 31 is derived from the preliminary reservoir and downhole fluid data 2. The calculated radius of investigation 35 is then compared at 39 to the expected range of variation derived from the preliminary reservoir and downhole fluid data 2. This objective is not met unless the calculated radius of investigation 35 lies within the expected range of variation (e.g., the reservoir boundary is found at a distance within the expected range).

If the test objective is met, the measurement and acquisition of data of this well test parameter (e.g., radius of investigation) can be terminated at 41. If the test objective is not met, measurement and acquisition of data are continued at 43 until the test objective is met. Thus, well test sequences and duration can be optimized.

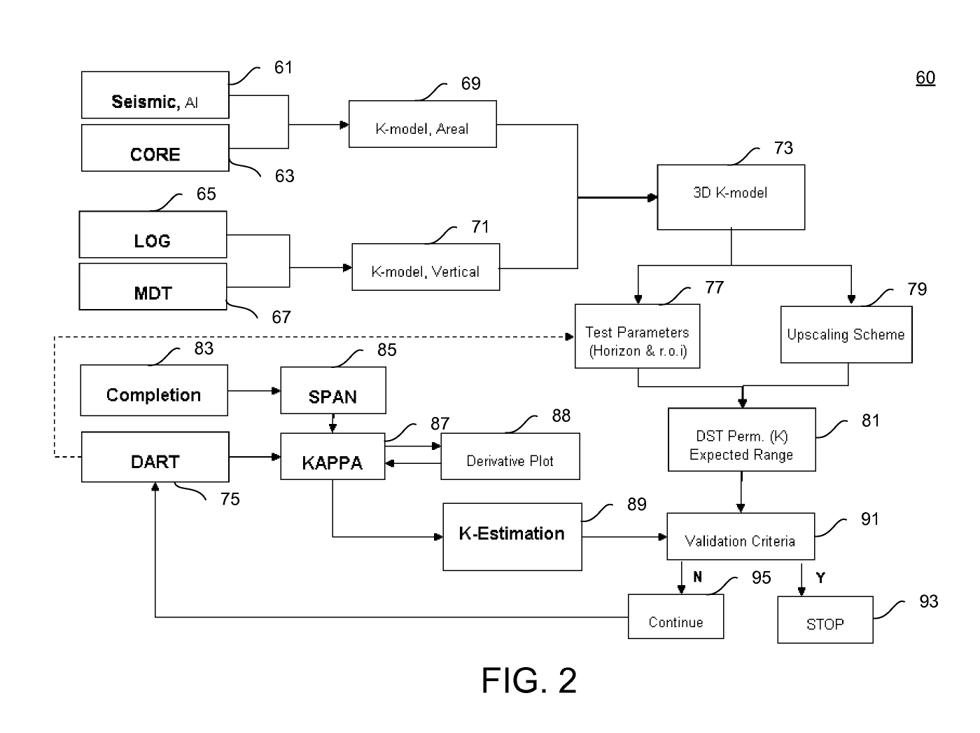

FIG. 2 is used to illustrate another exemplary method and system 60 adapted to the well test parameter reservoir permeability. In FIG. 2, the preliminary reservoir and downhole fluid data originate from seismic data 61 (e.g., a map of acoustic impedance), core analysis 63, well logs 65, and formation testing 67, such as modular reservoir dynamics testing (MDT), but may also include repeat formation testing (RFT). From these data, an expected range of reservoir permeability can be derived (e.g., vertical 71 as well as horizontal 69).

As the well tests start, the measured data are gathered through a data acquisition and reporting tool (DART) 75 and interpreted in real-time using interpretation software 87 (e.g., SAPHIR from Kappa Engineering) to obtain an estimated reservoir permeability 89 and based on input/output from/to a derivative plot 88. For certain well test data 77 (e.g., testing horizon and r.o.i.), the 3D permeability data 73 can be up-scaled at 79 to determine the expected drillstem tests (DST) permeability range 81. The effect of completion 83 on the well test data may be estimated using appropriate tools 85 (e.g., Schlumberger Perforation Analysis (SPAN) software tool). The estimated reservoir permeability 89 from well-test interpretation is then compared at 91 to the expected range of the reservoir permeability 81.

In case of consistency between the two values, the well test objective is considered to be achieved, and the measurement and acquisition of data for this well test parameter (e.g., reservoir permeability) can be terminated at 93. Otherwise, measurement and acquisition of data is continued at 95 until the well test objective is met.

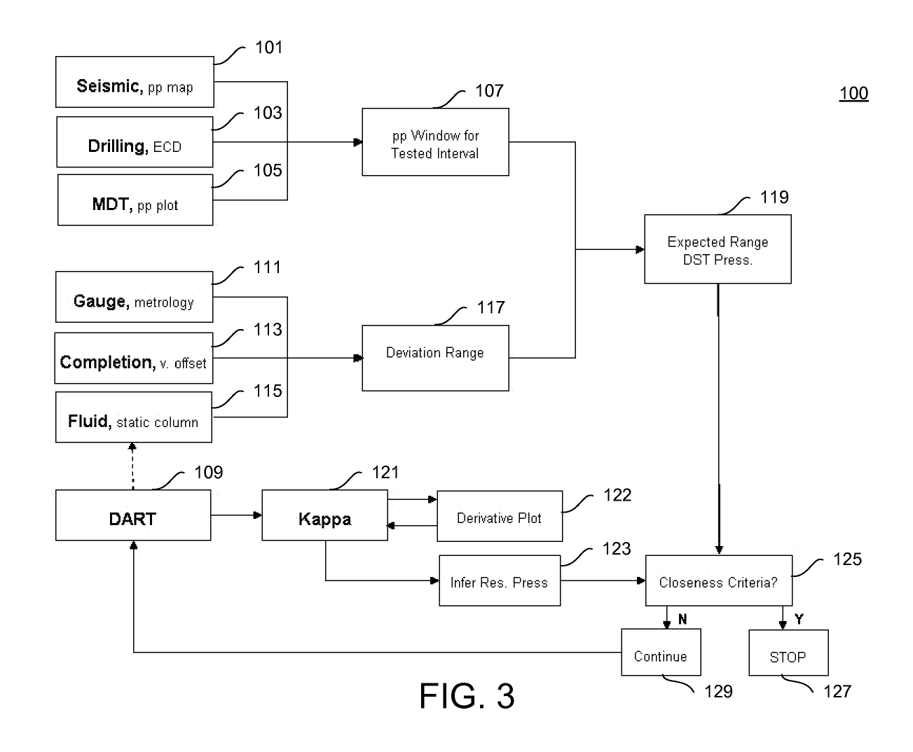

FIG. 3 is used to illustrate yet another exemplary method and system 100 adapted to the well test parameter initial reservoir pressure. In FIG. 3, a first step to estimate an expected variation range of the initial reservoir pressure 119 includes using seismic data 101 (e.g., estimate of pore pressure map), drilling information data 103 (e.g., mud weight reports), and formation testing data 105 (e.g., MDT). These data provide a pore pressure window 107.

As the well test starts, the pressure is measured by a downhole pressure gauge 111, and the pressure data are gathered through a data acquisition and reporting tool (DART) 109. The measured pressure data during the well test depends on the position of the pressure gauge 111 in the wellbore, on the existence of the static fluid column in the well 115, and on the type of completion 113. Therefore, the pore pressure window 107 is corrected according to these operational constraints to obtain a deviation range 117 of the pore pressure window 107. The expected variation range 119 of the initial reservoir pressure is then determined by combining the pore pressure window 107 with its deviation range 117.

The measured pressure data are interpreted using interpretation tool 121 to obtain the initial reservoir pressure 123 and based on input/output from/to a derivative plot 122. The inferred reservoir pressure 123 is then compared at 125 to the expected variation range 119 of the initial reservoir pressure. The well test objective is met if the inferred reservoir pressure 123 lies within the expected range 119 of the initial reservoir pressure.

If the test objective is met, the measurement and acquisition of pressure data can be terminated at 127. If the test objective is not met, measurement and acquisition of data is continued at 129 until the test objective is met.

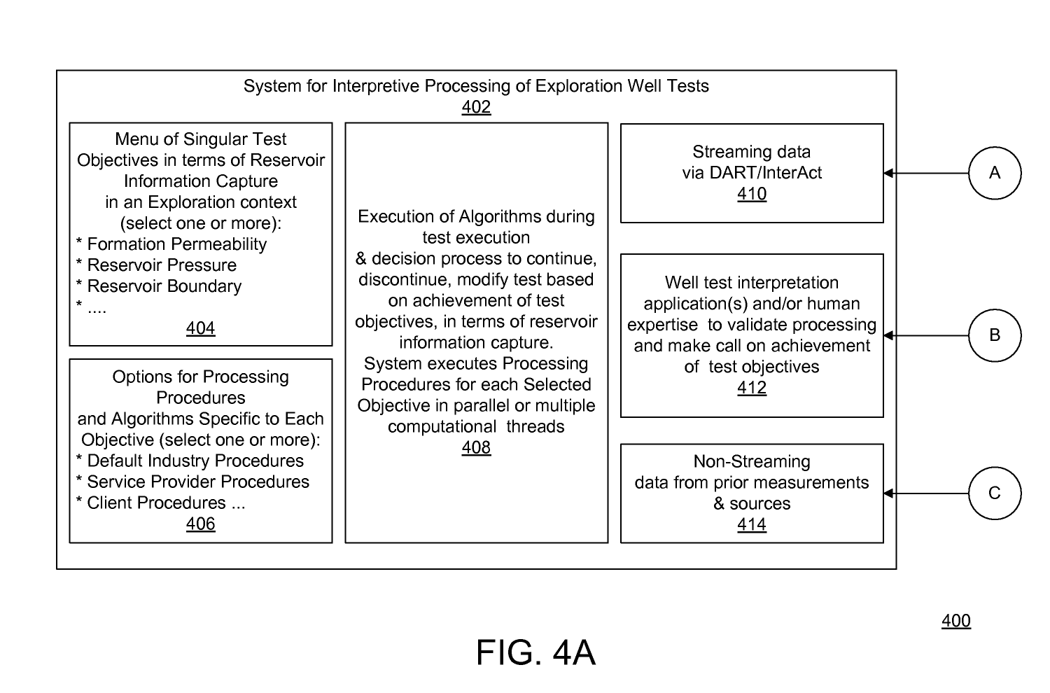

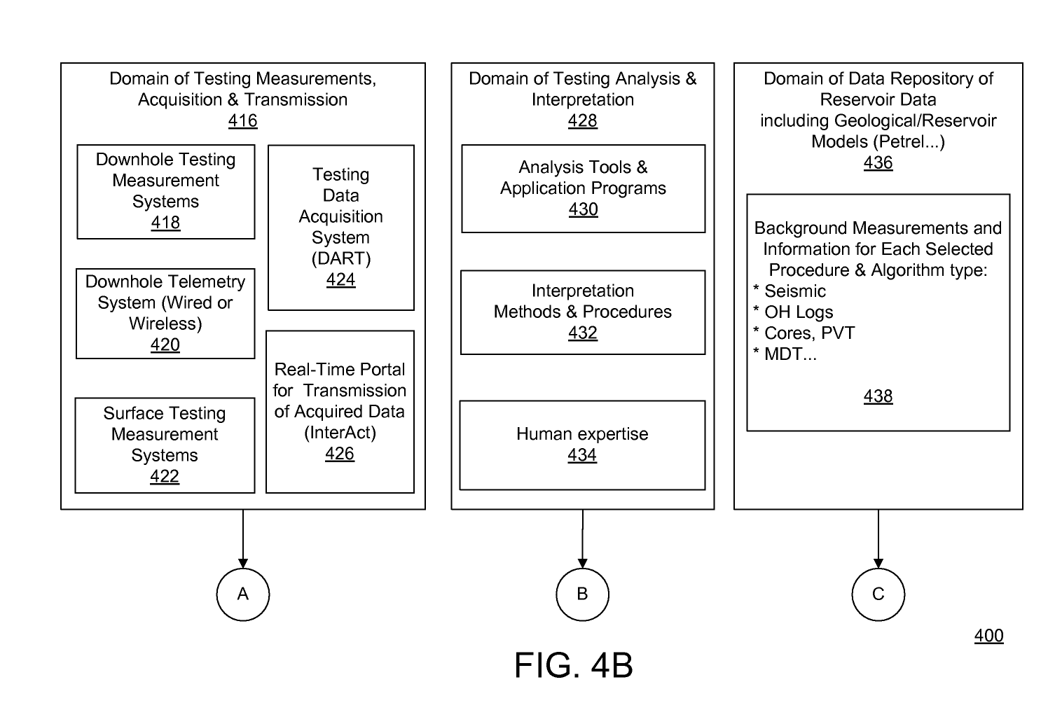

FIGS. 4A-4B are used to illustrate an exemplary method and system that can be used with the exemplary embodiments of FIGS. 1-3. In FIGS. 4A-4B, the exemplary system and method 400 includes an exemplary system 402 for interpretative processing of exploration well tests. The system 402 can include a menu 404 of singular test objectives in terms of reservoir information capture in an exploration context and provide selections for one or more test objectives, such as formation permeability, reservoir pressure, reservoir boundary, and the like.

The system 402 then can provide options for processing procedures and algorithms specific to each objective at 406, including default industry procedures, service provider procedures, client procedures, and the like. The system 402 then can provide for execution of algorithms during test execution and decision processes to continue, discontinue, modify, and the like, a test based on achievement of test objectives, for example, in terms of reservoir information capture at 408, wherein the system 402 can execute processing of procedures for each selected objective in parallel or multiple computational threads, and the like.

The execution at 408 can be based on (i) streaming data via various applications (e.g., DART/InterAct), based on input received from a domain of testing measurements, acquisition and transmission 416, (ii) well test interpretation application(s) and/or human expertise to validate processing and make a determination on achievement of test objectives at 412, based on input received from a domain of testing analysis and interpretation 428, (iii) non-streaming data from prior measurements and sources 414, based on input received from a domain of data repository of reservoir data 436 (e.g., including Geological/Reservoir Models (e.g., Petrel) etc.), and the like.

The domain of testing measurements, acquisition and transmission 416 can include (i) downhole testing measurement systems 418, (ii) downhole telemetry systems 420 (e.g., wired and/or wireless), (iii) surface testing measurement systems 422, testing data acquisition systems 424 (e.g., DART), (iv) real-time or near-real-time portals 426 for transmission of acquired data (e.g., InterAct), and the like.

The domain of testing analysis and interpretation 428 can include (i) analysis tools and application programs 430, (ii) interpretation methods and procedures 432, (iii) human expertise 434, and the like.

The domain of data repository of reservoir data 436 can include (i) background measurements and information 438 for each selected procedure and algorithm type, including seismic data, open hole (OH) log data, core log data, pressure-volume-temperature (PVT) data, modular reservoir dynamics testing (MDT) data, and the like.

As will be appreciated by those skilled in the relevant art(s), the exemplary embodiments can be adapted or customized for local conditions or characteristics of the well, the formation, and the like. In addition, the exemplary embodiments can be adapted for other well test parameters, test objectives, and the like, as will be appreciated by those skilled in the relevant art(s).

During a well test, several well test parameters may have to be determined. According to the exemplary embodiments, the test objective for a specific well test parameter can be considered independently from the others (e.g., referred to as “atomization” of test objectives). This means that a test objective is examined separately for each well test parameter, each test objective has its own sources of preliminary reservoir and downhole fluid data, and each test objective has its own analysis process, as described with respect to FIGS. 1-4. In this way, advantageously, it can be ensured that each test objective can be met, wherein the well test is continued until the test objectives for all investigated well test parameters are met. In addition, the exemplary methods and systems ensure that the “interpretability” of the measurement data during the well test (e.g., specific reservoir information or well test parameters, which have motivated the test) can actually be obtained.

FIGS. 5-12 illustrate an exemplary method and system for well test design and interpretation, according to exemplary aspects of the present disclosure, and which can be used alone or in combination with the embodiments of FIGS. 1-4 and 13-17. In FIGS. 5-12, an exemplary Test Design and Interpretation Process (TDIP) includes analytical interpretation methodology for real-time well monitoring and deriving reservoir characteristics from analysis of transient pressure data obtained by downhole permanent gauges, in association with permanent (or e.g., regular) surface or downhole data (e.g., Vx rate data from Vx technology). The methodology is based on a continuous analysis of the pressure and rate data in decline-curve analysis for wells with a variable downhole flowing pressure, or through more sophisticated models that can be based on the ones used in well testing analysis. Because the interpretation is conducted while continuing production, the exemplary system and method are particularly well suited for a well or group of wells under extended testing, which are equipped with downhole gauges and are flowing through surface separation and metering systems.

To complement the real-time analytical interpretation methodology, continuous pressure and rate measurements at different well locations can be used to probe the reservoir to obtain its properties for history matching with a detailed reservoir simulator. Furthermore, because the data are dynamic and direct, pressure and production data, and pressure transient testing, which can be performed cost-effectively and frequently, for example, with the Vx technology, can provide needed information for well productivity and dynamic reservoir description, for enabling efficient production and reservoir engineering, and the like. Pressure testing can also show that a formation can flow and can provide productivity index, reservoir pressure, permeability, heterogeneity, and the like. Integrated by the TDIP, fluid-flow simulation, geology, time-lapse seismic images, geostatistics, rock physics, reflection seismology, and the like, can provide spatially distributed continuous pressure and flow rate measurements to enable continuous dynamic data for reservoir characterization at the well-to-well scale.

As pressure transient testing interpretation is still expert and experience intensive, the exemplary TDIP can be used to assist engineers' interpretation effort in a way that maximizes testing benefits to clients with well timed and verifiable results. With this novel system and method, recurring and easy tasks, such as sampling, data reduction, and the like, can be automated with overriding capabilities. On the other hand, uncertainties in reservoir models and non-uniqueness of the model, identification, and its estimates can be determined jointly by geoscientists and reservoir engineers by using automation and uncertainty systems. Because the novel system and method provide a most complete range of static and dynamic data at all suitable scales from wellhead to basins, the novel system and method can provide a unique advantage in Testing Services to obtain well productivity, to provide reservoir characterization and reserve, to determine connected volume, and the like, by adding value to pressure transient and flow rate data, and the like.

Accordingly, advantages of the TDIP method and system, include making the interpretation process seamless, using expertise and experience in real-time but with a remote capability, maximizing interpretation process automation, facilitating testing decisions, such as termination of a test, and the like, in real-time, quantifying uncertainty in the geological model and its estimates, accurate test design and planning, real-time data monitoring, well lift and production optimization, data access at any suitable time and at any suitable place, and validation, maintaining state-of-the-art expertise on the testing technology, validating reserve and productivity based on dynamic testing data, and the like.

Advantageously, the TDIP system and method can be web based, wherein the testing hardware, data, and models for the reservoir can be accessible to production companies, client testing engineers, designers, interpreters, and the like. Thus, the novel platform can provide a complete interpretation of pressure transient and flow rate data, and capture information at the end of the interpretation in a prompt, accurate and efficient manner. Automation and visualization can be an integral part of the novel platform.

The present disclosure includes recognition that, in the coming years, real-time monitoring of well and reservoir data will play a central role for well productivity and reservoir management. Accordingly, it is very important to respond timely to solve reservoir problems, and well productivity and production assurance. For ensuring effective monitoring, the exemplary system and method provide real-time interpretation via the TDIP, as monitoring systems evolve continuously, and can give a context for interpreting the significance of the data being monitored.

Accordingly, FIG. 5 is used to illustrate the exemplary TDIP system and method 500 for well test design. In FIG. 5, the exemplary system and method 500 includes a Testing Manager 502, including Testing Hardware and Gauge metrology, a Geological Model 504, such as a PETREL based geological model, Dynamic and Static Engineering Data Acquisition 506, and Reservoir Modeling 508.

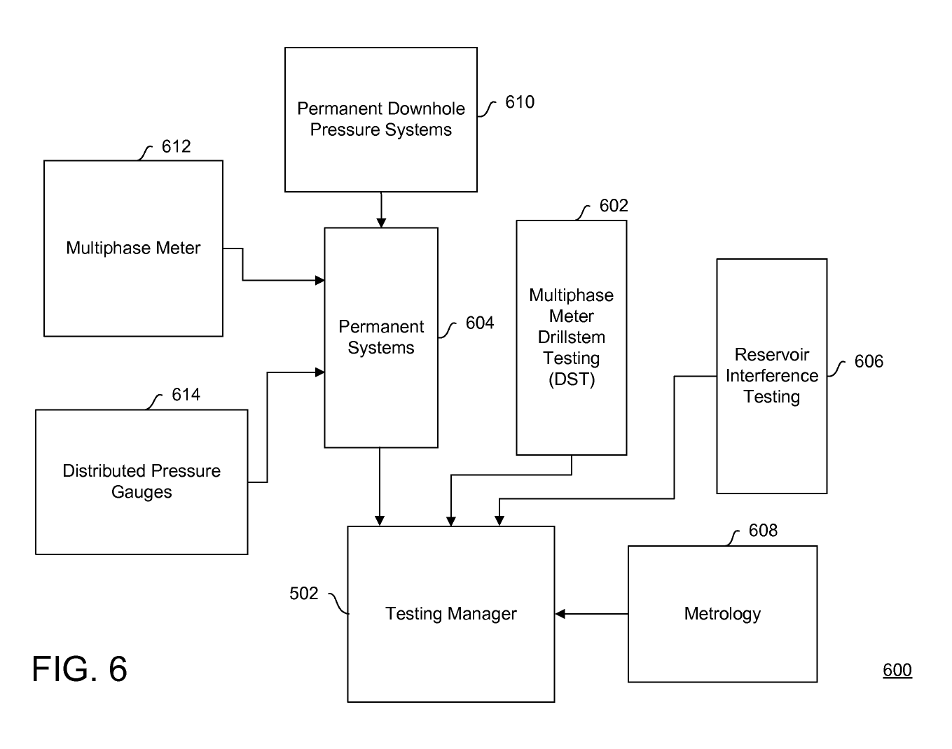

FIG. 6 is used to illustrate the exemplary Testing Manager 502, systems and processes 600 employed for the well test design and interpretation of FIG. 5. In FIG. 6, the exemplary Testing Manager 502 can receive data from various instrumentation, such as a multiphase meter drillstem testing (DST) 602, e.g., an assignee's DST, Permanent Systems 604, Reservoir Interference Testing 606, and Metrology 608. The Permanent Systems 604 can include Permanent Downhole Pressure systems 610, a multiphase meter 612, and Distributed Pressure Gauges 614, including Smart plugs, Smart casing, and the like.

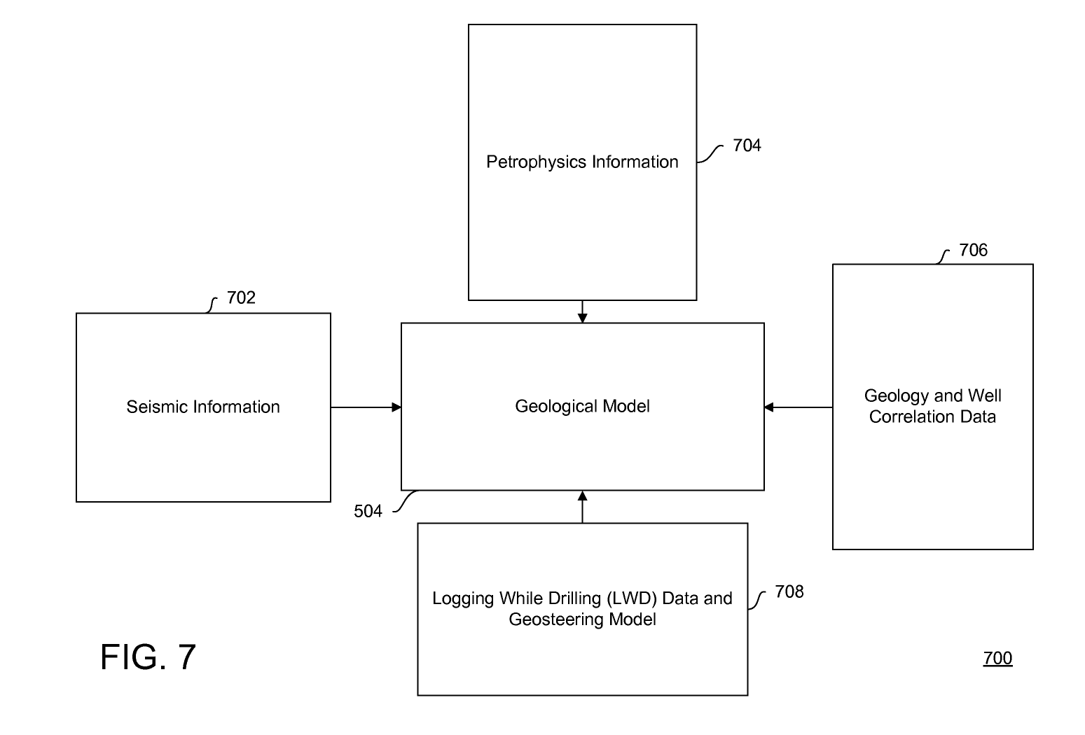

FIG. 7 is used to illustrate the exemplary Geological Model 504 systems and processes 700 employed for the well test design and interpretation of FIG. 5. In FIG. 7, the exemplary Geological Model 504 can be based on Seismic information 702, Petrophysics information 704, Geology and Well Correlation data 706, and Logging While Drilling (LWD) data and Geosteering model 708.

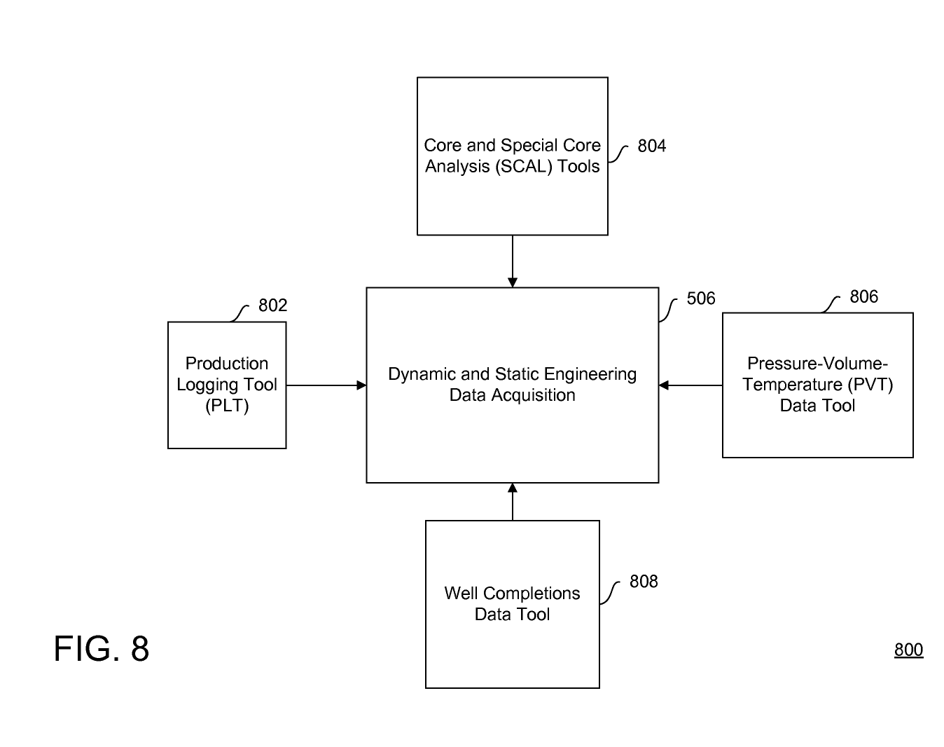

FIG. 8 is used to illustrate the exemplary Dynamic and Static Engineering Data Acquisition 506 systems and processes 800 employed for the well test design and interpretation of FIG. 5. In FIG. 8, the exemplary Dynamic and Static Engineering Data Acquisition 506 can include a Production Logging Tool (PLT) 802, Core and Special Core Analysis (SCAL) tools 804, Pressure-Volume-Temperature (PVT) data tool 806, and Well Completions data tool 808.

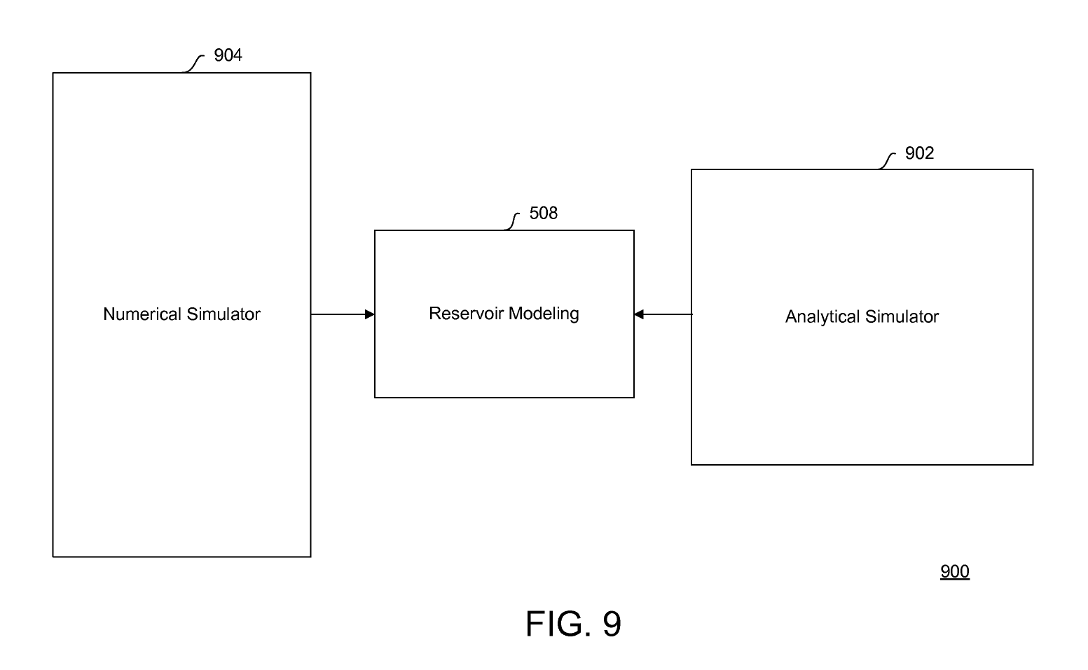

FIG. 9 is used to illustrate the exemplary Reservoir Modeling 508 systems and processes 900 employed for the well test design and interpretation of FIG. 5. In FIG. 9, the exemplary Reservoir Modeling 508 can include an Analytical Simulator 902 and a Numerical Simulator 904.

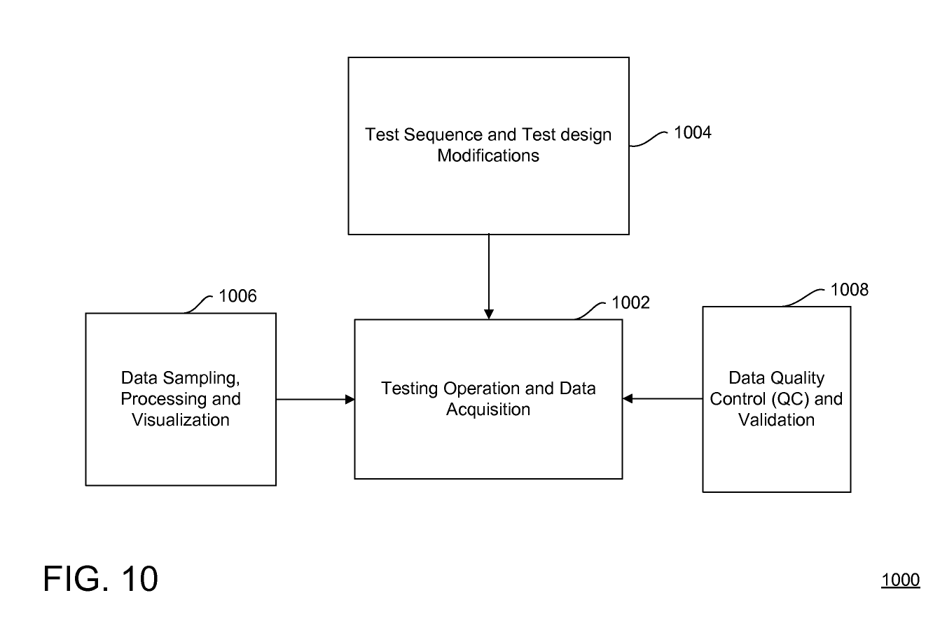

FIG. 10 is used to illustrate exemplary Testing Operation and Data Acquisition systems and processes 1000 employed for well test design and interpretation processes. In FIG. 10, the exemplary Testing Operation and Data Acquisition systems and processes 1000 can include Testing Operation and Data Acquisition 1002, including Test sequence and Test design modifications 1004, Data Sampling, Processing and Visualization 1006, and Data Quality Control (QC) and Validation 1008.

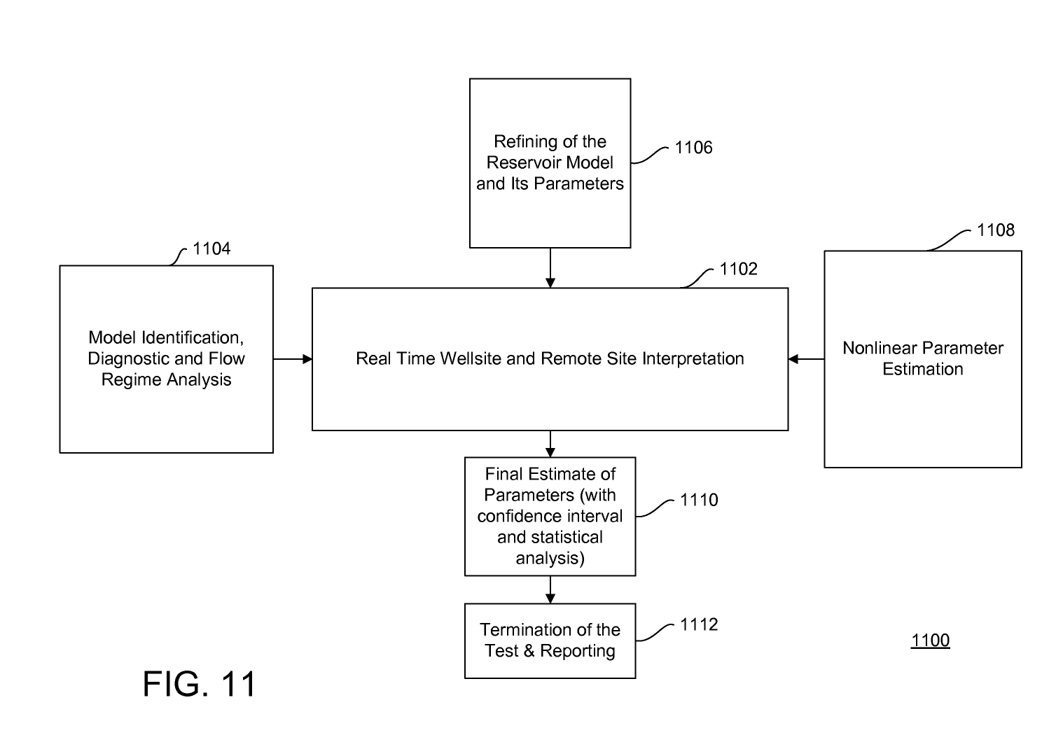

FIG. 11 is used to illustrate exemplary Real Time Wellsite and Remote Site Interpretation systems and processes 1100 employed for well test design and interpretation. In FIG. 11, the exemplary Real Time Wellsite and Remote Site Interpretation systems and processes 1100 can include Real Time Wellsite and Remote Site Interpretation 1102, including Model identification, Diagnostic and Flow regime analysis 1104, Refining of the Reservoir Model and Its Parameters 1106 (e.g., Initialization, Conditioning, Calibrating, Scaling, Range, Weight Assigning, etc.), and Nonlinear Parameter Estimation 1108 (e.g., History Matching) using Analytical and/or Numerical Solutions of the Reservoir Models and Least-Squares (L-S) and/or Maximum Likelihood (ML) Regression Techniques to generate a Final Estimate of Parameters 1110 (e.g., with confidence interval and statistical analysis) and for Termination of the Test and Reporting 1112.

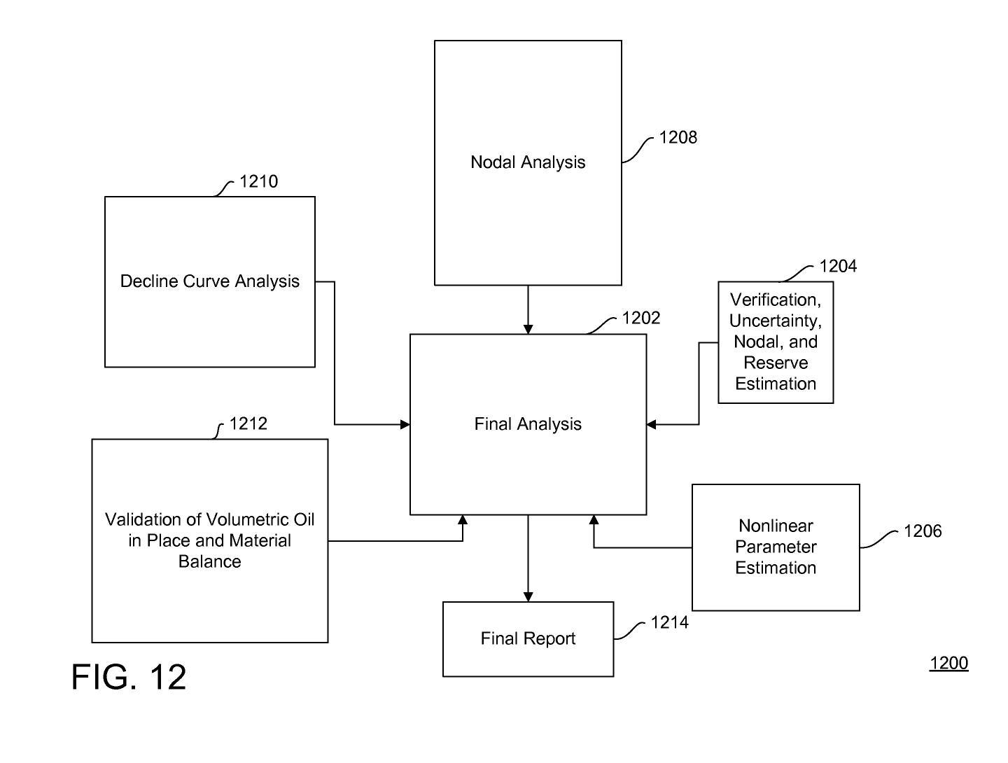

FIG. 12 is used to illustrate exemplary Final Analysis systems and processes 1200, including Verification, Uncertainty, Nodal, and Reserve Estimation employed for well test design and interpretation. In FIG. 12, the exemplary Final Analysis systems and processes 1200 can include Final Analysis 1202, including Verification, Uncertainty, Nodal, and Reserve Estimation 1204, based on Refining the Reservoir Model and Its Parameters 1106, Nonlinear Parameter Estimation 1206 using Analytical and/or Numerical Solutions of Reservoir Models and Least-Squares (L-S) and/or Maximum Likelihood (ML) Regression Techniques, Nodal Analysis 1208, Decline Curve Analysis 1210, and Validation of volumetric oil in place and Material Balance 1212 to generate a Final Report 1214.

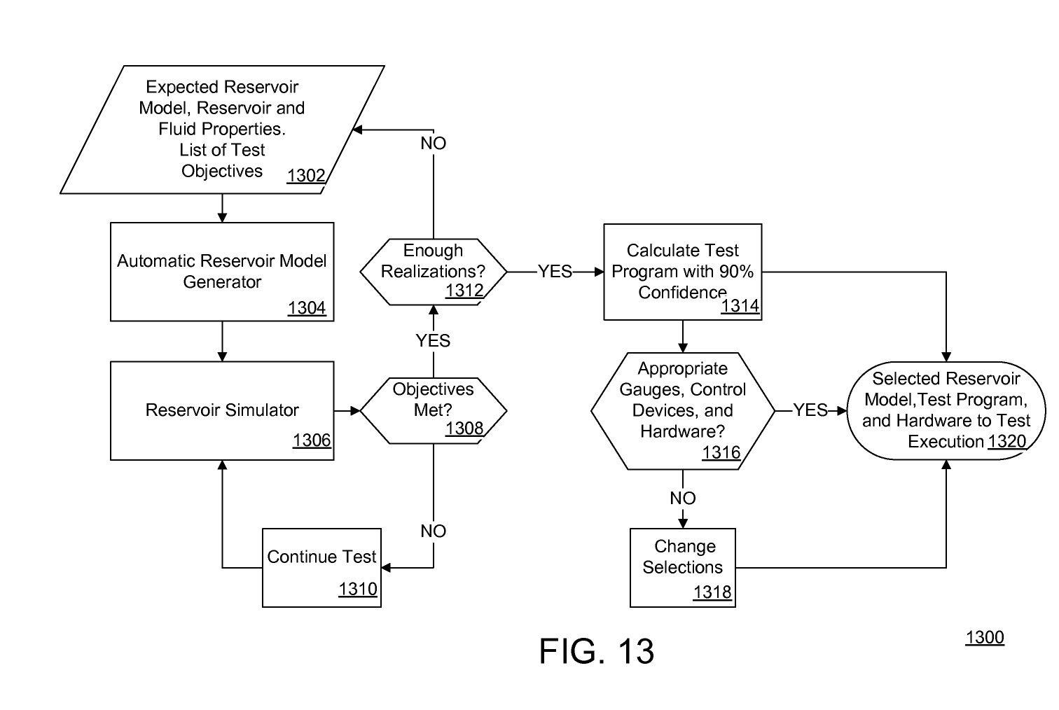

FIGS. 13-17 are used to illustrate an exemplary method and system for well test design and interpretation, according to exemplary aspects of the present disclosure, and which can be used alone or in combination with the embodiments of FIGS. 1-12. In FIGS. 13-17, the Testing Design and Interpretation Process (TDIP) workflow, in combination with a real-time data acquisition system, enables exploration and production, as well as reservoir testing engineers of service companies to enhance and add value to testing operations. The test design and its interpretation are considered as continuous processes, while the test data are received from the sensors via an acquisition system, until termination of the test.

The TDIP helps to reduce the uncertainties in complex geological systems. The reservoir model, which includes uncertainties and can be used to design a test, is continuously updated, as data are received by the TDIP in real- or near-real-time. The TDIP can synthesize measured data, such as pressure, temperature, and flow rates, with a geological model using simulation, and modeling and optimization tool boxes, integrated in the TDIP, and can update the reservoir model parameters to forecast the model behavior with anticipated specific flow behavior.

The real-time downhole and surface data received by, and interpreted in the TDIP, enables production and reservoir managers and engineers to make crucial decisions related to production efficiency, operations, safety, well completion and workover, and reservoir management. As each well represents a large investment in drilling and completion, the reservoir and well knowledge gained from dynamic testing data by the TDIP can help to reduce the number of development wells required, provide a better prediction of reservoir performance, and provide the ability to pinpoint future infill drilling opportunities.

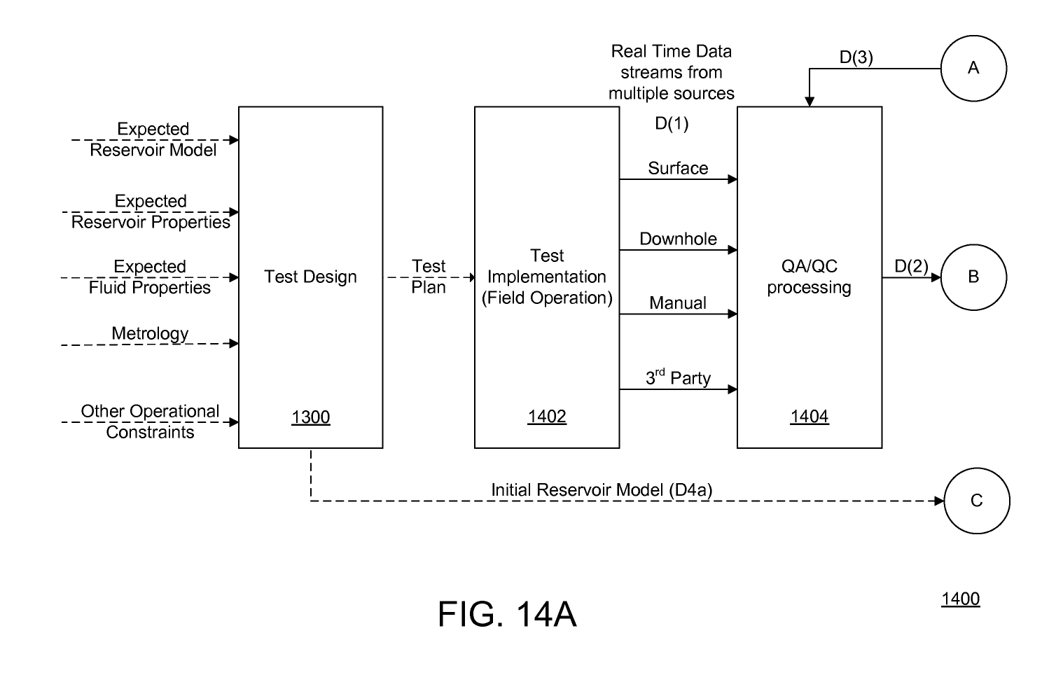

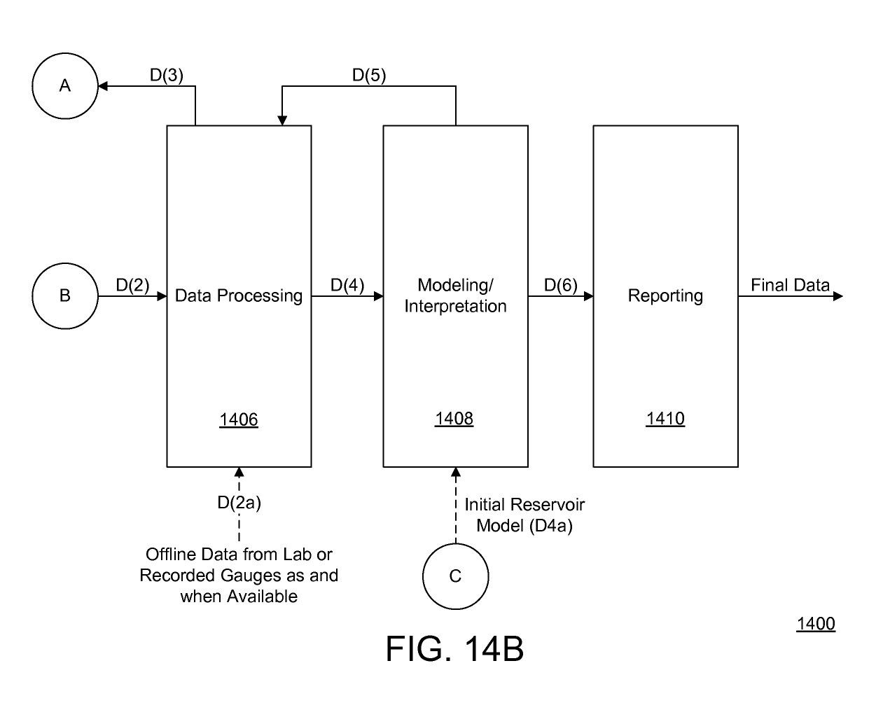

The exemplary embodiments are used to detail the entire workflow of the TDIP in the design, acquisition and interpretation and describe the processes involved. The overall TDIP Workflow is shown in FIGS. 14A-14B, and includes a multi-step workflow including a preliminary design stage of FIG. 13, which includes steps and inputs employed for designing a well test operation prior to its implementation. Because of the high level of uncertainties about the reservoir and fluid properties, the output of the stage of FIG. 13 can include an expected distribution of test plans. The plan which guaranties, for example, with 90%-95% statistical confidence, achievement of all suitable test objectives, may then be chosen for implementation.

In FIG. 13, the data input step 1302 includes a list of test objectives, which can be used to guide the TDIP. Expected reservoir models are also provided to take into account expectation of the reservoir behavior from the points of view of various disciplines. The expected reservoir model input can be in the form of simple analytical models or more complicated numerical reservoir models derived from a more complex geological model. This can include any suitable information about the reservoir layering, existence of fractures and faults, etc. In both cases, the TDIP platform provides an appropriate connection with either kind of simulator to facilitate data and results exchange before and during the test implementation. Expected reservoir properties also are provided along with their corresponding range of uncertainty. This provides the opportunity to run more realizations of the reservoir behavior and calculate the range of uncertainties on the total test duration needed to achieve the test objectives. Expected fluid properties also are provided along with their expected range of accuracy. Metrology, including specifications of the available gauges for a certain job, also can be input into the TDIP prior to testing. According to an appropriate test design, a check is made as to whether or not the current measurement devices are capable of accurate data acquisition, to a level that is needed for accurate interpretation.

Based on the input data of step 1302, a series of realizations of a well test are simulated and a series of total well test durations are generated at steps 1304-1320. This is done considering any suitable limitations in measurement devices. The output of this stage at step 1320 is a distribution of total test duration, which enables the achievement of the test objectives with regard to the limitations in measurement systems. A decision is then made to select a test plan which can guarantee the achievement of the test objectives. Since a distribution of duration is available, selection of the test duration, and its corresponding test program, which provides at least 90% statistical confidence for meeting the test objectives, can be recommended. Advantageously, the TDIP provides an interactive workflow and the test program can be terminated earlier or extended beyond the base plan, depending on whether or not the test objectives are met.

During the test operation, there is a flow of dynamic data to the exemplary system, including dynamic pressure data. In a standard well test operation, pressure is measured downhole, at the wellhead and also at the separator point. More than one pressure gauge can be employed for downhole pressure (e.g., to check for data quality) and dynamic wellhead pressure (e.g., casing and tubing wellhead pressure). In the case of interference testing, input from nearby wells can also be employed. Temperature is also measured at more than one point, and for example can practically be measured wherever pressure is measured. Flow rates of fluid produced during the test are measured as accurate as possible and the production data are employed as a dynamic input to the TDIP platform. With respect to fluid properties, the TDIP receives input for continuous measurements of the fluid properties, such as density, specific gravity, viscosity, gas-to-oil ratio (GOR), basic sediment and water (BSW), and the like. These measurements might not directly influence the whole testing process, but they can be used to monitor and quality control (QC) other acquired data. For example, monitoring BSW gives a very good indication of the end of well clean-up period.

Advantageously, the TDIP allows for the real-time monitoring, QC and validation, processing, and visualization during the data acquisition process. The real-time data acquired during the test are imported to an interpretation and optimization toolbox. Starting from the existing reservoir model, which is built integrating all suitably available data (e.g., geology, geophysics, drilling, well logs, etc.), the effect of production is simulated using reservoir simulators at step 1306 and the model parameters are accordingly adjusted to match the real-time reservoir behavior at steps 1302-1304 and 1308-1312. The benefit of real-time history matching of the reservoir behavior is reduction of the uncertainty range in reservoir parameters. As the test continues and the uncertainties are narrowed down, the test can be designed and the test program can be revised corresponding to the dynamic data acquired. The test is then continued until the achievement of the objectives.

Apart from the application of real-time data in interpretation and optimization process, the data are also used in a standard well test analysis toolbox for diagnostic purposes. Accurate tracking of the rate and pressure data makes it possible to diagnose different flow regimes.

Accordingly, various processes are integrated in the TDIP workflow of FIGS. 13-17, and which cover a wide range of applications from quality assurance (QA)/QC of the input data, to the non-linear optimization techniques and automated reservoir simulation tools. For example, in the Reservoir Simulator step 1306 of FIG. 13, the TDIP establishes links to both analytical and numerical reservoir simulators. Analytical reservoir simulators are used for the cases in which the reservoir has been known and there is not a great deal of uncertainties in reservoir and fluid properties, and wherein standard procedure of well testing can be employed. Numerical reservoir simulators are employed for more complex cases, for example, for unknown and uncertain reservoir and model parameters, and where a more detailed reservoir model is employed to perform more accurate and certain interpretations.

The Automatic Model Generator step 1304 of FIG. 1 can be employed and integrated in the TDIP because of its frequent use in both design and optimization sections. In a design step of the test, the automatic model generator step 1304 generates different realizations of the expected reservoir model based on a random sampling of the expected reservoir model, and reservoir and fluid properties. In the optimization section, the model generator step 1704 constructs the reservoir model based on the property improvements resulting from a non-linear parameter optimization process.

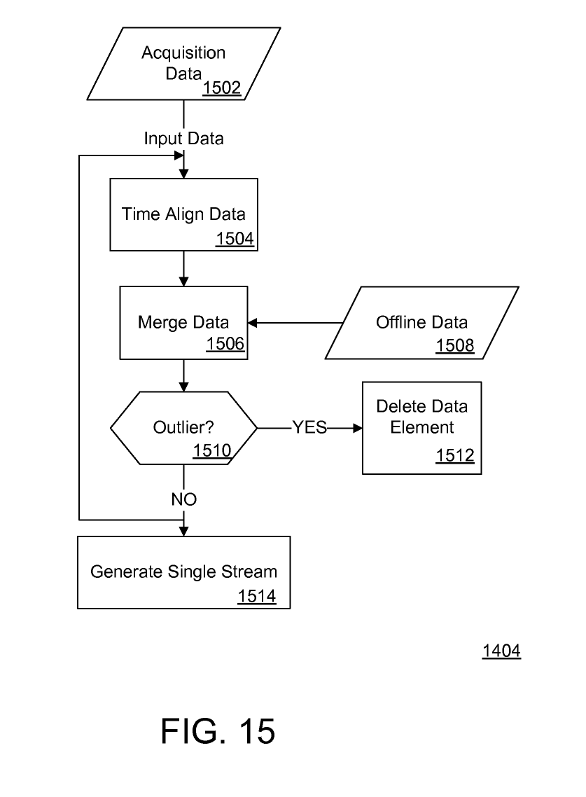

The Data QA/QC processing step 1404 of FIGS. 14A and 15 handles connecting/loading of data that can be from different sources. The main data entries for the TDIP are pressures and flow rates (e.g., dynamic data), and well, reservoir fluid and rock properties. In addition to data input prior to the test and the data inflow during the test, there are data generated as a result of computation processes in the reservoir simulator step 1306 and reservoir model updates in step 1304. These data are used as an input to other stages of calculation and optimization and therefore are subjected to the QA/QC processing step 1404 as well. Data input as a result of new information about the reservoir model and reservoir fluids properties also are subjected to the QA/QC processing step 1404. Accordingly, any suitable updated data are subjected to the quality check process of step 1404.

The QA/QC process step 1404 also provides a methodology for data interpreters to have a good understanding of the general data quality, testing sequences and events, and optimization and history matching (e.g., interpretation) steps. This methodology, advantageously, allows proper performance of the Data Processing step 1406. Accordingly, the advantage of the QA/QC process step 1404 is to allow one to diagnose and understand the wellbore, formation and/or tool related issues, during the test and failures of the simulator or optimization steps during the optimization process.

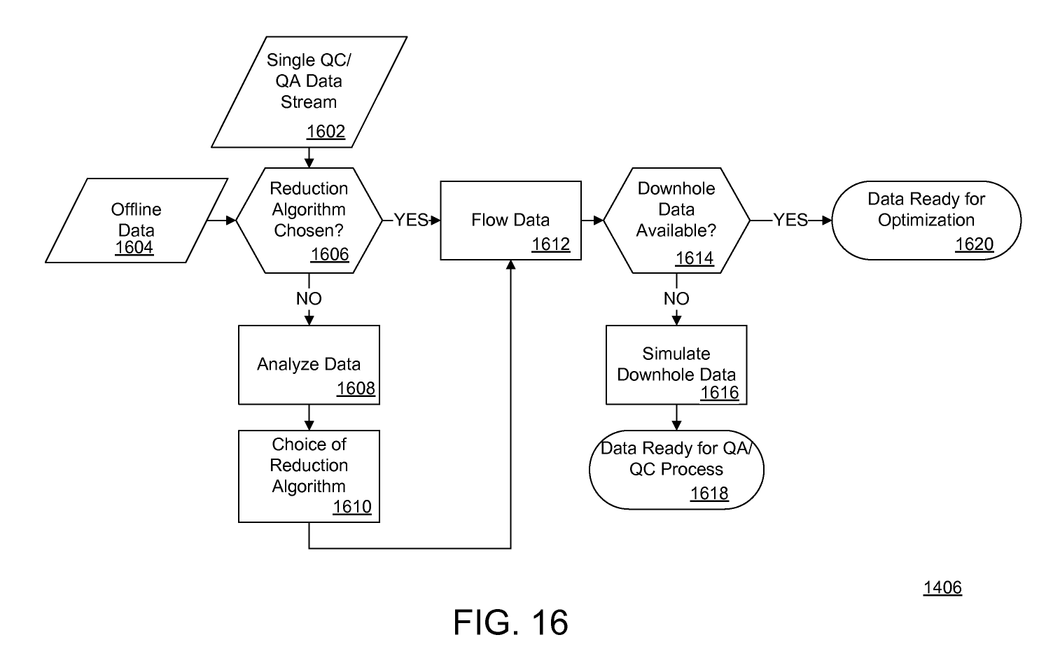

The Data Processing process step 1406 of FIGS. 14B and 16 minimizes the TDIP interpretation and computer execution time, advantageously, guaranteeing that the dynamic formation and well behavior is completely captured. The Data Processing step 1406 tasks can include removing unessential data, reducing high frequency and other noise, data smoothing (e.g., for zigzag data), reconstructing missing information, and the like.

In order to minimize the non-linear regression execution time, the actual data points used in the non-linear parameter estimation process can be reduced to a manageable number of data points. Given today's computing capabilities, it is generally accepted that less than a thousand dynamic data points are sufficient to perform parameter estimation, without missing any significant well and formation information. A data reduction procedure, for example, based on any suitable signal processing algorithms, and the like, can be used for this purpose.

A flexible flow rate handling (e.g., smoothing, interpolating, or any other suitable signal processing, etc.) can be a part of the data processing step 1406, because even in the case of accurate measurement of the flow rates, keeping a constant flow rate is not simple and normally one deals with noisy flow rate data. Advantageously, the TDIP provides the user with an efficient processing and validation module for the flow rates of the reservoir fluids.

A diagnostic log-log pressure derivative plot is used to check the quality of Data Processing step 1406 and the degree of data decimating. Advantageously, the Data Processing step 1406 is thorough enough so as not to distort well and formation pressure transient characteristic, such as semi-log and log-log derivative, for the system identification, and a proper reduction of pressure data is performed considering synchronization thereof with the rate data.

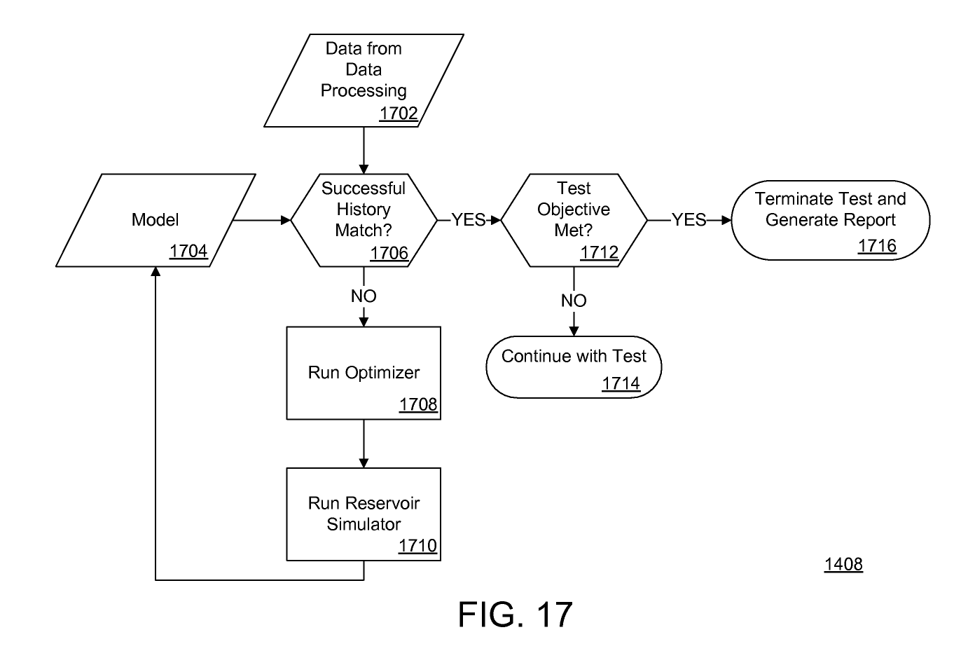

The Reservoir Modeling/Interpretation process step 1408 of FIGS. 14B and 17 employs pressure transient flow regimes for model identification and flow regime analysis. For example, a stabilized derivative on the log-log plot is an indication of infinite acting radial flow. In addition, identification of the system provides invaluable information about boundaries, fractures, faults, and the like. A transient flow regime analysis can be performed by using the semi-log and log-log plots of either pressure changes or derivatives. For example, a flat (e.g., zero) slope might appear in the derivative curve of the log-log plot, which might suggest the existence of the infinite-acting radial flow regime.

It is recognized that for many reservoir models, there exists a characteristic pressure behavior which can be identified based on the log-log plot of pressure derivative. This could be a great help to interpretation and test engineers in deciding which model to use, simply by observing this plot. However, special attention should be given to the fact that occurrence of a specific characteristic signature depends on the corresponding flow regime. For example, appearance of the wellbore storage effect is normally known as an early time behavior, while the effect of a boundary (or boundaries) shows up in the late time response of the reservoir. Advantageously, diagnosis on the reservoir model is done within an appropriate time range to see its effects. In addition, the diagnosis performed on the test data, as the data is acquired, is performed in line with the well test objectives. For example, the test is not continued towards detection of a boundary, unless this is stated as a test objective.

Any suitable non-linear parameter optimization algorithm can be integrated in the TDIP in order to history-match the test pressure/rate data versus the outputs from reservoir simulator step 1306. The optimization, advantageously, can be used to determine a reservoir model and reservoir properties that have the highest probability of providing real world behavior, as measured during the test, and under the same conditions of the test. The initial parameter estimates of reservoir and well parameters can include the mean value expected from other sources of information, gathered as input data.

The inverse problem of estimating unknown formation parameters of the previously constructed formation and well model can be formulated as a nonlinear optimization problem, which can be solved analytically or numerically. Parameter estimation can be performed by using weighted least square (WLS), for which weights are assumed to be known, or maximum likelihood estimation (MLE). The minimization of the objective functions can be achieved by using the Levenberg-Marquardt algorithm with a restricted step. In addition to the estimated parameters, statistical analysis of these parameters, including confidence interval and correlation coefficients, are computed using standard definitions or algorithms, and which are very useful for identifying which parameters can be determined reliably from the available data.

The present disclosure includes recognition that if the un-weighted least square (UWLS) estimation method is used for data sets having disparate orders of magnitude, then the data sets with large magnitudes will dominate those having small magnitudes in the estimation. Thus, information contained in data sets with small magnitudes will be lost. Also, in cases where some observations are less reliable than others, it is desirable to ensure that the parameter estimates will be less influenced by unreliable observations. To solve these and other problems, a WLS regression can be employed. Often, it is difficult to know the error variance structure in advance and, thus, it can be difficult to determine the proper weights to be used in the WLS regression. Accordingly, an efficient optimization method based on the maximum likelihood estimation (MLE), advantageously, can be included into this workflow. The main advantage of the new method over the WLS method is that it eliminates the trial-and-error procedure required to determine appropriate weights to be used in the WLS estimation. This provides significant improvement in parameter estimation when working with pressure data sets of disparate orders of magnitude and noise.

The efficiency of the non-linear regression algorithm and the reliability of the parameter estimates from the non-linear optimization can be influenced by the initial selection of parameters and their constraints (or e.g., variations/ranges). Accordingly, in the TDIP workflow, the non-linear optimization is constrained by defining lower and upper limits for the parameters. In addition, pressure, permeability, skin factor, storage, and the like, can be estimated using an expected value with a range of distribution for each parameter. The initial properties of the constructed reservoir model are also constrained by using different sources of information.

Sometimes it is difficult to obtain a reasonable match in a reservoir model with many unknowns after only one regression cycle. Therefore, an iterative procedure, where sometimes different processes of the TDIP workflow are employed, is used to constrain and enhance model and parameter estimation. In other words, uncertainties are reduced in the model and its estimated parameters by using the parameter estimates and statistics (e.g. confidence interval, correlation coefficients, etc.) from the previous regression as inputs. Advantageously, the reservoir model can be iteratively refined and its parameters can be iteratively adjusted. For example, the initial guess of parameters and their minimum and maximum ranges, the possible weights of each parameter, the number of parameters needed to be optimized, and the like, can be refined. At the end of each regression cycle, if the model and estimated parameters are accepted, then the modeling/interpretation process step 1408 is completed.

The Reporting process step 1410 of FIG. 14B is performed after termination of the test, when the meeting of the objectives is confirmed and the reservoir model is known within an acceptable range of uncertainty. The input, final, and intermediate results of calculation and history matching are exported to a reporting module of the reporting step 1410 to be used in a final well test report.

Thus, the workflow of the TDIP can include the design segment 1300 of FIGS. 13-14A and the implementation and interpretation segments 1402-1410 of FIGS. 14A-17, and which can be integrated together. However, since the activities performed in design segment are done before execution of the test, the design segment can be independent and can be connected to the other segments through the initial model. Updates in initial model and/or the test program can be done in the implementation and interpretation segments.

The design procedure of FIG. 13 of the TDIP incorporates the opportunity to consider expected range of reservoir and fluid properties inputs (e.g., parameters containing uncertainty) and to generate a range of test duration outputs, for example, using a stochastic simulation. The output step 1320 of the test design stage is a test program, which by 90% statistical certainty would guaranty achievement of the test objectives, advantageously, incorporating limitations in testing facilities (e.g., gauges, sensors, control devices, and surface hardware) in step 1316. The output of step 1320, stream D(4a), is then used as an input to the modeling/interpretation block 1408 of the TDIP workflow shown in FIG. 14A-14B.

FIGS. 14A-14B thus represent the overall workflow of the TDIP. The interpretation and optimization steps 1402-1408 provide for an iterative process with iterations based on arrival of new information or data. New information are processed and interpreted, integrated with the old information, upon acquisition. The new interpretation results are compared with the test objectives and decision to continue data acquisition is made based on the achievement of the test objectives. The test is then terminated and report is generated at step 1410 when all test objectives are met and the range of certainty of the interpreted parameters is within acceptable range.

The TDIP can employ the concept of processes acting on data streams. The data streams are of several types and can be real-time or near-real-time data streams, offline data streams, and the like. The further sub-classification of data streams, includes real-time Critical or True Real Time (e.g., typically within milliseconds from an event) data streams and Non critical or Near Real Time (e.g., typically within seconds from an event) data streams, such as D(1); offline data streams, such as D(2a); continuous data streams, for example, created by an automated process; manually created by data input and sporadic data streams, such as D(1); aggregated data streams, including a combination of all suitable data stream types to create a consolidated stream type; and the like.

In the QA/QC Processing step 1404 of FIGS. 14A and 15, the TDIP workflow includes the processing of the various streams of near- and real-time data from different acquisition sources from step 1502. In step 1504, the data is time aligned to ensure that the timing of the data streams is synchronized. In step 1506, the data is combined with offline data either from an offline data stream or manually entered data from step 1508. The resulting aggregated data stream can then be analyzed automatically and/or manually, running quality assurance and quality checks in steps 1510-1512. For example, data elements including spikes or drifting measurement can be removed in steps 1510-1512. The resulting stream of data is an aggregated data stream D(2) from step 1514.

The Data Processing step 1406 of FIGS. 14B and 16, at step 1602, receives the data stream D(2) from step 1514 of the QA/QC process step 1404 and the offline data D(2a) at step 1604. The data processing step 1406 employs an automated process for the reduction or summarizing of the data at steps 1606-1620. When step 1614 determines that downhole measurements are not available, step 1616 produces simulated values D(3), as an offline automated stream, to represent the missing data or data that will arrive after the fact. At step 1618, the data D(3) is fed back to the process step 1404 as an additional data input. When the offline data D(2a) from other sources, such as pressure/volume/temperature (PVT) labs or data from recorded gauges is available, the data processing step 1406 can replace all or part of the simulated data with the data D(2a) to advantageously reduce the uncertainty of the result. At step 1620, the data D(4) ready for optimization is then provided to the modeling/interpretation process step 1408.

The Modeling/Interpretation process step 1408 of FIGS. 14B and 17, at step 1704, receives the initial model, for example, based on an initial simulation of expected conditions, from information from the nearby wells or any suitable geological study of the area, and the like, as data D(4a), from the process step 1300. This serves as the initial model and with suitable assumptions. At step 1702, the data D(4) from the data processing process step 1406 is received and at steps 1706-1710 the modeling process 1408 iteratively enhances the model with new arriving data. The modeling process 1408 with successive iterations also allows the deletion of certain assumptions, and is sent to the process 1406 as the data D(5), advantageously, allowing for a more robust interpretation. Steps 1712-1716 then determine if the test objectives are met and continue with the test or terminate the test for generating a report based on output data D(6).

The Reporting process step 1410 of FIG. 14B employs the data D(6) from the modeling process 1408 and at any suitable point in time offering a snapshot of the work with the data available at that point in time. When no more new data is available, the reporting process step 1410 provides the final result or data.

Advantageously, the TDIP platform of FIGS. 13-17 provides for a complete interpretation of the pressure transient and flow rate data, and can capture and analyze information at the end of the interpretation in a prompt, accurate, and efficient manner, with automation and visualization as an integral part of the platform. In the near future, real-time monitoring of the well and reservoir data will play a central role for well productivity and reservoir management. Thus, it is very important to respond timely to solve reservoir problems, and maintain well productivity and production. To ensure effective well monitoring, the TDIP can provide real-time interpretation, even as monitoring systems evolve continuously, and can highlight the interpretation significance of wells being monitored.

The above-described devices and subsystems of the exemplary embodiments can include, for example, any suitable servers, workstations, personal computers (PCs), laptop computers, personal digital assistants (PDAs), Internet appliances, handheld devices, cellular telephones, wireless devices, other electronic devices, and the like, capable of performing the processes of the exemplary embodiments. The devices and subsystems of the exemplary embodiments can be configured to communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, the employed communications networks can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present disclosure. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present disclosure, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present disclosure can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present disclosure for performing all or a portion (if processing is distributed) of the processing performed in implementing the exemplary embodiments. Computer code devices of the exemplary embodiments of the present disclosure can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present disclosure can be distributed for better performance, reliability, cost, and the like.

As stated above, the devices and subsystems of the exemplary embodiments can include computer readable medium or memories for holding instructions programmed according to the teachings of the present disclosure and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present disclosure has been described in connection with a number of exemplary embodiments, and implementations, the present disclosure is not so limited, but rather covers various modifications, and equivalent arrangements, which fall within the purview of the appended claims.

What is claimed is:

1. A method for optimizing a well test in real-time, the well test being adapted to provide one or a plurality of well test parameters, the method comprising:
defining an expected variation range of data for each well test parameter independently from preliminarily determined reservoir and downhole fluid data; and
executing the well test for each well test parameter to obtain measured data;
processing the measured data for each well test parameter in real-time to obtain interpreted data;
comparing the interpreted data for each well test parameter to the corresponding expected variation range to determine if a test objective is met; and if not,
iteratively repeating the executing, the processing, and the comparing steps for each well test parameter until the test objective is met.

2. The method of claim 1, wherein the test objective comprises a predefined relationship between the interpreted well test parameter and the corresponding expected variation range.

3. The method of claim 1, wherein the well test parameter comprises a radius of investigation.

4. The method of claim 1, wherein the well test parameter comprises reservoir permeability.

5. The method of claim 1, wherein the well test parameter comprises initial reservoir pressure.

6. A system for optimizing a well test in real-time, the well test being adapted to provide one or a plurality of well test parameters, the system comprising:
a data measurement and acquisition downhole tool to execute the well test for each well test parameter to obtain measured data; and
a processor to process the measured data for each well test parameter in real-time to obtain interpreted data, to compare the interpreted data for each well test parameter to a corresponding expected variation range, previously defined for each well test parameter independently from preliminary reservoir and downhole fluid data, to determine if a test objective is met, and if not to allow the repeating of the test well execution of the measured data processing and of the interpreted data comparison for each well test parameter until the test objective is met.

7. A system for well test design and interpretation, the system comprising:
a testing manager system, including at least one of testing hardware and gauge metrology;
a geological model coupled to the testing manager system;
a dynamic and static engineering data acquisition system coupled to the geological model; and
a reservoir modeling system coupled to the dynamic and static engineering data acquisition system to generate a reservoir model.

8. The system of claim 7, wherein the testing hardware and gauge metrology includes one or more sensors for measurement of at least one of well downhole pressure, well surface pressure, well temperature, and well flow rate.

9. The system of claim 7, wherein the testing hardware and gauge metrology includes at least one of a multiphase meter for measuring the flow rate and the water, oil and gas fraction of the well effluent, drillstem testing (DST) system, a reservoir interference test system, a permanent downhole pressure system, and a distributed pressure gauge, including smart plugs or smart casing.

10. The system of claim 7, wherein the geological model is based on at least one of seismic information, petrophysics, geology and well correlation data, and logging while drilling (LWD) data and geosteering model.

11. The system of claim 7, wherein the dynamic and static engineering data acquisition system employs at least one of production logging tool (PLT) data, core analysis tool data, Special Core Analysis (SCAL) tool data, pressure-volume-temperature (PVT) tool data, and well completions tool data.

12. The system of claim 7, wherein the reservoir modeling system includes at least one of an analytical simulator, and a numerical simulator.

13. The system of claim 7, further comprising a test operation and data acquisition system, including at least one of test sequence and test design modifications, data sampling, processing and visualization, and data quality control and validation.

14. The system of claim 7, further comprising a real-time wellsite and remote site interpretation system, including at least one of model identification, diagnostic and flow regime analysis, refining of the reservoir model and parameters thereof including at least one of initialization, conditioning, calibrating, scaling, range, and weight, assigning, and nonlinear parameter estimation including history matching and based on at least one of analytical and numerical solutions of the reservoir model and at least one of least squares and maximum likelihood regression techniques,
wherein the real-time wellsite and remote site interpretation system is configured to generate a final estimate of parameters including at least one of confidence interval and statistical analysis, and is further configured to terminate testing and reporting.

15. The system of claim 7, further comprising a final analysis system, including at least one of verification, uncertainty, nodal, and reserve estimation, based on at least one of refining of the reservoir model and parameters thereof, nonlinear parameter estimation based on at least one of analytical and numerical solutions of the reservoir model and at least one of least squares and maximum likelihood regression techniques, nodal analysis, decline curve analysis, and validation of volumetric oil in place and material balance,
wherein the final analysis system is configured to generate a final report.

16. The system of claim 7, wherein the system is configured for making decisions related to well production efficiency, well operations, well safety, well workover, and well reservoir management based on at least one of the measurements of the well downhole pressure, well surface pressure, well temperature, and well flow rate in real-time.

17. The system of claim 7, wherein the system is configured for acquiring data continuously from the testing hardware and gauge metrology with downhole pressure measurements for real-time interpretation for optimizing at least one of well completion, perforation, lift, production, and recovery.

18. The system of claim 7, wherein the system is configured for synthesizing well test measurements, including at least one of pressure, flow rate, and temperature with the geological model to model such measurements and anticipate an encounter of geological features, including at least one of faults, and fractures, during testing, in order not to terminate well testing prematurely.

19. The system of claim 7, wherein the system is configured for continuously updating the reservoir model as data is received,
wherein the testing manager provides real-time connections to at least one design, interpretation, and toolboxes.

20. A method for well test design and interpretation corresponding to the system of claim 7.

21. An apparatus for well test design and interpretation, corresponding to one or more of the devices of the system of claim 7.

22. A method for well test design and interpretation, the method comprising at least one of:
generating a test plan and an initial reservoir model based on at least one of an expected reservoir model, reservoir properties, reservoir fluid properties, and metrology;
generating data streams based on the test plan from at least one of real-time, near-real-time, surface, downhole, and manual data sources;
generating an aggregated data stream based on quality control or assurance on the data streams;
generating data for optimization based on the aggregated data stream and simulated downhole data sent to the quality control or assurance;
modeling or interpreting of the optimization data including reservoir simulation and modeling to determine if test objectives are met for terminating or continuing the test plan and generating data sent to the generating data for optimization step for modifying assumptions therein; and
reporting data received from the modeling or interpretation when terminating the test plan.

23. A system for well test design and interpretation corresponding to the method of claim 22.

24. A computer program product for well test design and interpretation and including one or more computer readable instructions embedded on a computer readable medium and configured to cause one or more computer processors to perform the steps of the method of claim 22.
